(19) United States
(12) Patent Application Publication
(10) Pub. No.: US 2006/0277278 A1
(43) Pub. Date: Dec. 7, 2006

(54) Distributing workload among DNS servers

(75) Inventors: Nikhil Hegde, Austin, TX (US); Rashmi Narasimhan, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/146,440

(22) Filed: Jun. 6, 2005

(51) Int. Cl. G06F 15/177; G06F 15/173

(52) U.S. Cl. 709/220; 709/223

(57) ABSTRACT

A method, apparatus, and computer instructions for managing a domain name system (DNS) translation request transmitted to a group of DNS servers. When a DNS request is received at the first DNS server in the group, the length of the input queue at the first DNS server is determined. If the length of the input queue exceeds a predetermined value, then the DNS request is sent to a second input queue at a second DNS server before the DNS request is added to the first input queue. Consequently, the mechanism of the present invention provides for sending DNS requests to whichever DNS server in the group has the shortest queue length and balancing DNS requests across a group of DNS servers

### BACKGROUND OF THE INVENTION

1. Technical Field

The present invention relates generally to an improved data processing system and in particular to a method and apparatus for processing data. Still more particularly, the present invention relates a method, apparatus, and computer instructions for distributing DNS translation requests.

2. Description of Related Art

Users of the Internet typically visit a particular Website by entering a domain name or universal resource locator (URL) into a browser. From the user's perspective, the URL is entered into the client browser and subsequently the client browser receives content back from the server supporting the Website. For example, a user may visit a Website maintained by International Business Machines Corporation by typing “ibm.com” into the client's browser.

However, a computer cannot reach the Website using the alphanumeric URL directly. Instead, the browser needs a numerical Internet protocol (IP) address in order to find the host server containing the desired Web site content. An example of an IP address is 12.345.678.90.

In order to obtain an IP address for the Website, the client browser receives a translation of the URL into the appropriate IP address. Currently, a domain name system (DNS) is maintained to accommodate the translation. The DNS is a system of databases and data processing systems that allow a URL to be translated into an IP address and an IP address to be translated into a URL.

When a URL is entered into the client browser, the client browser transmits the URL to a DNS server, which is usually located at a remote geographic location. The DNS server translates the URL into an IP address and transmits the IP address back to the client browser. The client browser then uses the IP address to access the host server.

Because most clients use the domain name system, DNS servers process a vast number of transactions daily. Accordingly, businesses that maintain DNS servers often maintain large groups of DNS servers.

Typically, a DNS translation request (DNS request) arrives at a first DNS server in the group of DNS servers. If the first DNS server is too busy to process the request, in the sense that the time to process the DNS request exceeds a predetermined value, then the DNS request times out. The DNS request is then passed to the next server in a sequential list of servers. The process continues until the DNS request arrives at a DNS server that has a short enough input queue to process the DNS request before the DNS request times out.

A problem associated with this method of processing DNS requests is that DNS servers further down the list are underutilized while the DNS servers at the top of the list are overburdened. As a result, the resources available to the DNS server group are underutilized and any given DNS request may take longer than necessary to process. Thus, it would be advantageous to have an improved method, apparatus, and computer instructions for distributing a DNS translation request workload among individual DNS servers in a group of DNS servers.

### SUMMARY OF THE INVENTION

The present invention provides a method, apparatus, and computer instructions for managing a domain name system (DNS) translation request transmitted to a group of DNS servers. When a DNS request is received at the first DNS server in the group, the length of the input queue at the first DNS server is determined. If the length of the input queue exceeds a predetermined value, then the DNS request is sent to a second input queue at a second DNS server before the DNS request is added to the first input queue such that DNS requests are sent to whichever DNS server in the group has the shortest queue length.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented.

FIG. 2 is a block diagram of a data processing system that may be implemented as a server in which the present invention may be implemented.

FIG. 3 is a block diagram illustrating a data processing system in which the present invention may be implemented.

FIG. 4 is a block diagram of a known client data processing system transmitting a DNS request to a group of DNS servers.

FIG. 5 is a block diagram of a client data processing system transmitting a DNS request to a group of DNS servers in accordance with a preferred embodiment of the present invention.

FIG. 6 is a flowchart illustrating a method of managing a DNS request at a group of DNS servers in accordance with a preferred embodiment of the present invention.

### DETAILED DESCRIPTION OF THE PREFERRED EMBODIMENT

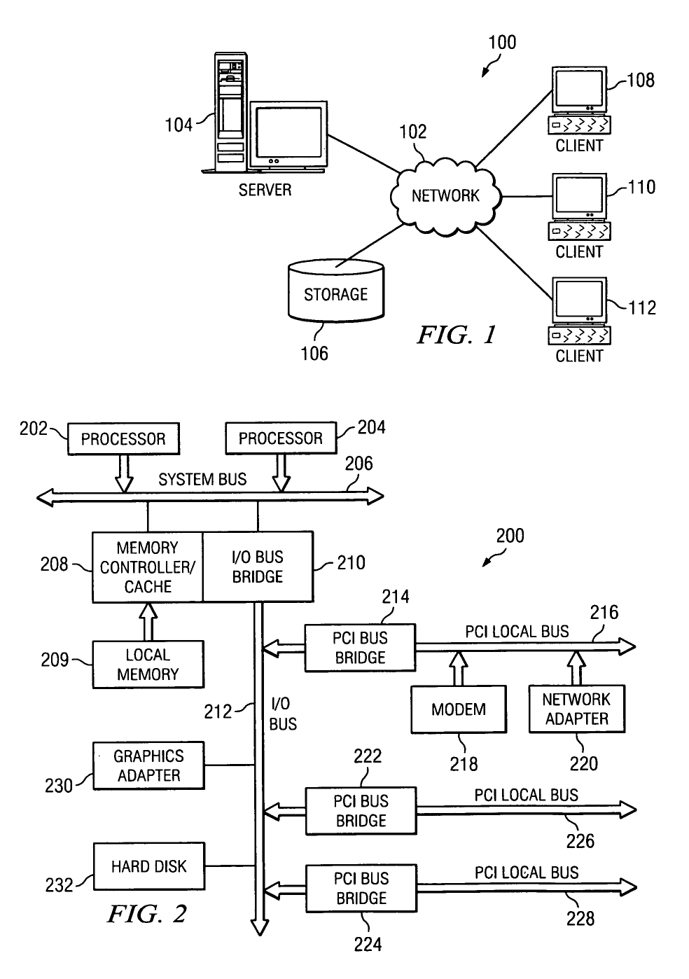

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eserver pseries system, a product of International Business Machines Corporation in Armonk, N.Y., running the Advanced Interactive Executive (AIX) operating system or LINUX operating system.

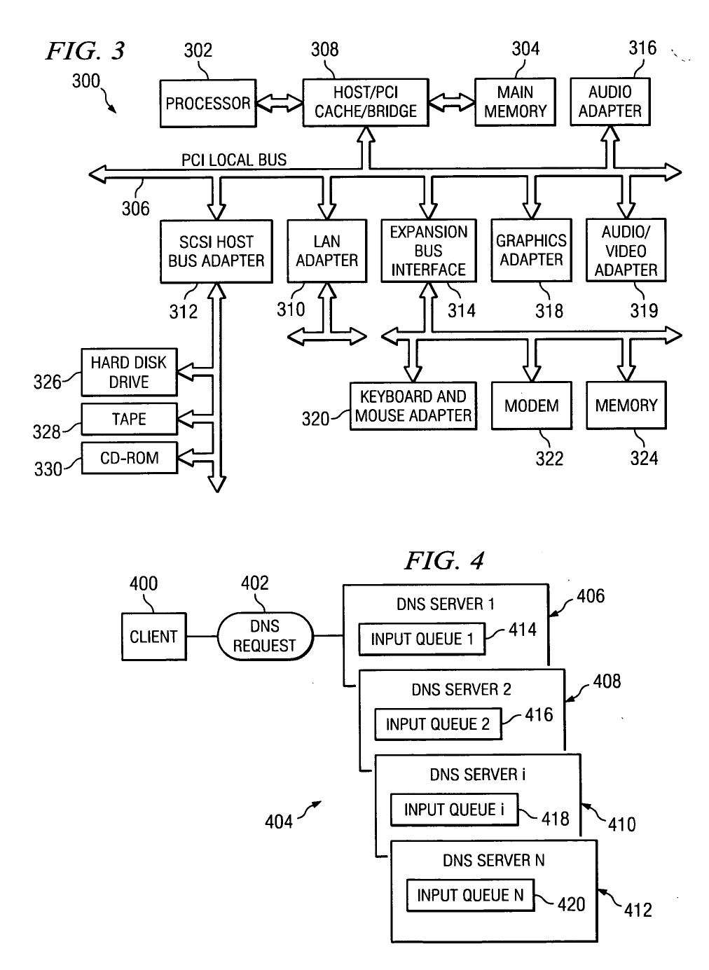

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. In addition, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer instructions for managing a domain name system (DNS) translation request transmitted to a group of DNS servers. When a DNS request is received at the first DNS server in the group, the length of the input queue at the first DNS server is determined. If the length of the input queue exceeds a predetermined value, then the DNS request is sent to a second input queue at a second DNS server before the DNS request is added to the first input queue. Consequently, the mechanism of the present invention provides for sending DNS requests to whichever DNS server in the group has the shortest queue length and balancing DNS requests across a group of DNS servers

FIG. 4 is a block diagram of a known client data processing system transmitting a DNS request to a group of DNS servers. Client data processing system 400 may be a data processing system such as client 108, 110, and 112 in FIG. 1, and may also be a system such as client 200 in FIG. 2. DNS request 402 may be transmitted by any suitable means over any suitable medium, including network 102 in FIG. 1 or the Internet. Each DNS server 406, 408, 410, and 412 may be any data processing system suitable for processing DNS requests, and may be server 104 in FIG. 1, or server 300 in FIG. 3.

In a known method for translating a DNS request, a client data processing system 400 transmits a DNS request 402 to a group 404 of DNS servers. Group of DNS servers may include one, several, or all of DNS server 1 406, DNS server 2 408, DNS server i 410, and DNS server N 412. Thus, group 404 of DNS servers includes a plurality of DNS servers having N DNS servers, where DNS server i 410 is a specific DNS server number. Generation of DNS request 402 at client 400 is performed using known software or hardware techniques. Similarly, transmission of DNS request 402 is performed in these examples using known hardware and software and hardware techniques. Processing of DNS request 402 at group 404 of DNS servers is performed using known hardware and software techniques in the following example.

Continuing the known example, DNS server 1 406 receives DNS request 402 and adds DNS request 402 to first input queue 414 of a first DNS server. If DNS request 402 waits more than a predetermined value of time in first input queue 414, such as eight seconds, then DNS request 402 will “time out” and be dropped from first input queue 414. DNS request 402 will then be transferred to second input queue 416 in DNS server 408. Again, if DNS request 402 waits more than a predetermined value of time in second input queue 416, then DNS request 402 is transferred to the input queue of the next DNS server. DNS request 402 is passed from the input queue of one server to the input queue of the next server, such as input queue 418, in this manner until input queue 420 DNS server N 412 is reached. If DNS request 402 waits more than a predetermined time in input queue 420 of DNS server N 412, then the request is either transferred back to DNS server 1 406 or is dropped completely from the group 404 of DNS servers. In the latter case, a notification of a failed DNS request may be transmitted back to client 400. However, if DNS request 400 is successfully processed, then the DNS translation is transmitted back to client 400.

The currently used method described above places a heavy workload on DNS server 1 406, with the workload decreasing at each subsequent DNS server down the list of DNS severs. DNS server 1 406 has the heaviest workload, DNS server 2 408 has a lower workload than DNS server 1 406, DNS server i 410 has a lower workload than DNS server 2 408, and DNS server N 412 has the least workload. Consequently, the known method fails to take advantage of the available resources on DNS servers further down the list of DNS servers. Each succeeding DNS server down the list of DNS servers is successively underutilized, such that DNS server N 412 may not be used at all. Thus, it would be advantageous to have a method, apparatus, and computer instructions for evenly distributing the total workload of DNS requests across group 404 of DNS servers.

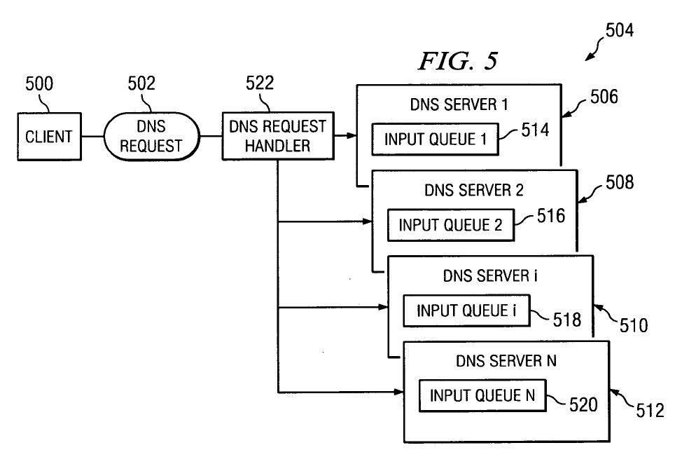

FIG. 5 is a block diagram of a client data processing system transmitting a DNS request to a group of DNS servers in accordance with a preferred embodiment of the present invention. Client data processing system 500 may be a data processing system such as client 108, 110, and 112 in FIG. 1, and may also be a system such as client 200 in FIG. 2. DNS request 502 may be transmitted by any suitable means over any suitable medium, including network 102 in FIG. 1 or the Internet. Each DNS server 506, 508, 510, and 512 may be any data processing system suitable for processing DNS requests, and may be server 104 in FIG. 1, server 300 in FIG. 3, or any of the DNS servers shown in FIG. 4.

In an illustrative example of the present invention, a client data processing system 500 transmits a DNS request 502 to a group 504 of DNS servers. Group 504 of DNS servers may include one, several, or all of DNS server 1 506, DNS server 2 508, DNS server i 510, and DNS server N 512. Thus, group 504 of DNS servers includes a plurality of DNS servers having N DNS servers, where DNS server i 510 is a specific DNS server number. Generation of DNS request 502 at client 500 is performed using known software or hardware techniques. Similarly, transmission of DNS request 502 is performed in these examples using known hardware and software and hardware techniques. Translation of DNS request 502 once DNS request 502 passes through an input queue and reaches a particular DNS server is performed using known hardware and software techniques.

In contrast to the known method shown in FIG. 4, a DNS request handler 522 is provided to manage DNS request 502. As with the process described in FIG. 5, client 500 transmits DNS request 502, which is intended for group 504 of DNS servers. However, DNS request handler 522 performs tasks described below to manage DNS request 502. DNS request handler 522 may be implemented using any suitable hardware or software, such as multiplexers, data processing systems, routers, switches, scripts, programs, or other applications. In a preferred illustrative embodiment, each DNS server 506, 508, 510, and 512 includes a separate DNS request handler. Each DNS server routs an incoming packet through its own DNS request handler and determines whether to accept incoming DNS request 502. In other embodiments, DNS request handler 522 may be separate from group 504 of DNS servers or may be integral with one of the DNS servers in group 504 of DNS servers. Thus, DNS request handler 522 may intercept DNS request 502 before DNS request 502 arrives at any of the DNS servers, or DNS request 502 may be processed by a separate DNS handler at each DNS server.

Once DNS request 502 arrives, DNS request handler 522 examines the length of input queue 1 514 of DNS server 1 506. DNS request handler 522 then makes a determination whether the length of input queue 1 514 is greater than a predetermined value. DNS request handler 522 may make this determination by measuring the length of time required to process input queue 1 514, or by counting the number DNS requests pending in input queue 1 514 if the shortest timeout value of DNS request 502 and the average processing time of DNS request 502 are measured.

If the length of input queue 1 514 is less than a predetermined value, then DNS request handler 522 adds DNS request 502 to input queue 1 514. On the other hand, if the length of input queue 1 514 is greater than the predetermined value, then DNS request handler 522 transfers DNS request 502 to another DNS server in the group 504 of DNS servers. For example, DNS request handler 522 may transfer DNS request 502 to one of input queue 2 516, input queue i 518, or input queue N 520. The transfer takes place before DNS request 502 is added to input queue 1 514 in order to save time. In another illustrative embodiment, the transfer takes place after DNS request 502 is added to input queue 1 514, but before DNS request 502 times out.

DNS request handler 522 may select any untried DNS server in the group 504 of DNS servers. In an illustrative embodiment, DNS request handler 522 maintains a list of DNS servers and linearly or sequentially attempts to assign DNS request 502 to one DNS server at time. Thus, DNS request handler 522 attempts to sequentially transfer DNS request 502 from input queue 1 514, to input queue 2 516, eventually to input queue i 518, and ultimately to input queue N 520 if the lengths of all other input queues are too long. In another illustrative embodiment, DNS request handler 522 actively monitors the length of the input queue of each DNS server and dynamically selects the next input queue based on the DNS server having shortest input queue length, or based on some other parameter.

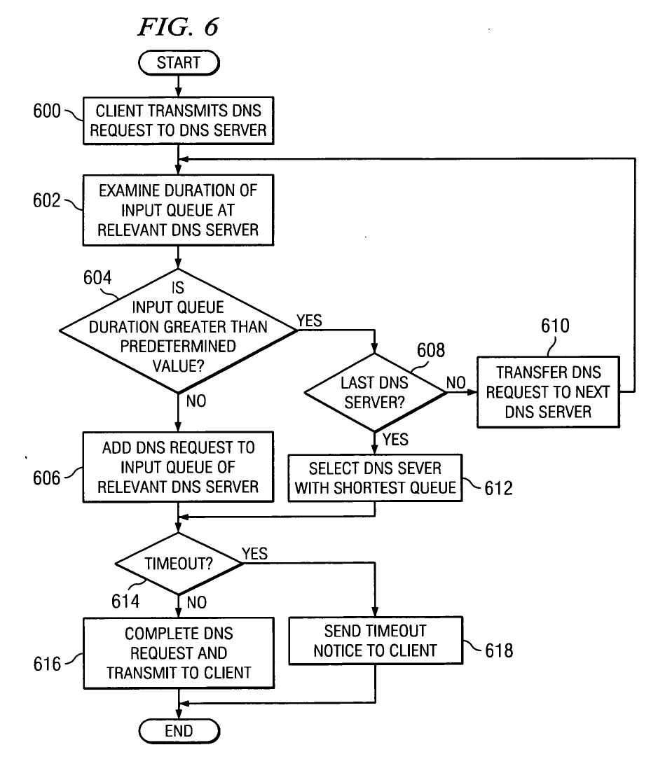

FIG. 6 is a flowchart illustrating a method of managing a DNS request at a group of DNS servers in accordance with a preferred embodiment of the present invention. The method illustrated in FIG. 6 may be implemented in the system shown in FIG. 4 or FIG. 5, in server 104 in FIG. 1, server 300 in FIG. 3, in a DNS server, or in any data processing system suitable for processing DNS requests.

The illustrative method may be implemented using any suitable software or hardware technique. In the illustrative embodiment, the method is implemented using a DNS request handler that may take the form of software, such as a script, set of instructions, or computer readable program code; hardware, such as a router, multiplexer, switch, or processor; or a combination thereof. Software resides in the memory of a data processing system and a processor implements the software. The software may be installed on a DNS server in the group of DNS servers, or may be installed on a separate data processing system operably connected to the group of DNS servers. Likewise, hardware may be a part of a DNS server or may be separate hardware operably connected to the group of DNS servers.

The process proceeds as follows. The client data processing system transmits a DNS request to a group of DNS servers (step 600). Once the DNS request is received at the group of DNS servers, a DNS request handler examines the length of the input queue at a first DNS server in the group of DNS servers (step 602). The DNS request handler then makes a determination whether the length of the input queue at the first DNS server is greater than a predetermined value (step 604). The DNS request handler may make this determination by measuring the length of time required to process the input queue, or by counting the number DNS requests pending in the input queue if the shortest timeout value of a DNS request and the average processing time of a DNS request are measured.

If the length of the input queue at the first DNS server is less than the predetermined value, then the DNS request handler adds the DNS request to the input queue of the first DNS server (step 606). On the other hand, if the length of the input queue at the first DNS server is greater than the predetermined value, then the DNS request handler makes a determination whether the DNS request handler has already attempted to place the DNS request in all of the DNS servers within the group of DNS servers (step 608). If the DNS request handler has not yet attempted to place the DNS request into the input queue of at least one DNS server within the group, then the DNS request handler transfers the DNS request to another DNS server in the group of DNS servers (step 610). The transfer takes place before the DNS request is added to the input queue of the first server in order to save time. In another illustrative embodiment, the transfer takes place after the DNS request is added to the input queue, but before the DNS request times out. The process then repeats, returning to step 602.

The DNS request handler may select any other untried DNS server in the group of DNS servers. In an illustrative embodiment, the DNS request handler maintains a list of DNS servers and linearly or sequentially attempts to assign DNS requests to one DNS server at time. In another embodiment, the DNS request handler actively monitors the length of the input queue of each DNS server and dynamically selects the next DNS server based on the DNS server having shortest input queue length, or based on some other parameter.

Returning to step 608, if the DNS request handler has already failed to place the DNS request into the queue of every DNS server, then the DNS request handler selects the DNS server having the shortest input queue length (step 612). The DNS request handler then allows the DNS request to be placed into the input queue of that DNS server. In another illustrative embodiment, the DNS request handler may continue to attempt to place a DNS request until the DNS request handler finds a DNS server having a short enough input queue length. For example, the DNS request handler may attempt to place the DNS request sequentially in each succeeding DNS server in the group of DNS servers. In yet another illustrative embodiment, the DNS request handler may place the DNS request in the input queue of a random DNS server. In yet another illustrative embodiment, the DNS request handler may drop the unassigned request and transmit a failed request signal to the client.

After the DNS request handler assigns the DNS request to the input queue of a DNS server, either during step 606 or step 612, then the relevant DNS server monitors the time the DNS requests spends in the input queue. The relevant DNS server or the DNS request handler then evaluates whether the DNS request times out (step 614). If the time the DNS request spends in the queue exceeds a predetermined value, then the request times out. In this case, the DNS server or the DNS request handler transmits a signal to the client transmitting the request has timed out and has been dropped (step 618). Otherwise, the DNS server completes the DNS request and transmits an appropriate response to the client (step 616). Whether the DNS request is dropped or completed, the process terminates thereafter.

In an illustrative example, a group of DNS servers includes three DNS servers, A, B, and C. The shortest timeout value for a DNS request is one second. The average time to process a DNS request is 20 milliseconds. Consequently, a particular packet will timeout if more than 1/(20*10⁻³)=50 packets are pending in the input queues of each DNS server.

A client generates a DNS request and transmits the DNS request to the group of DNS servers. The DNS request handler attempts to place the DNS request in the input queue of DNS server A. The DNS request handler detects that 50 packets are pending in the input queue of DNS server A. Because the DNS request would timeout if placed in the input queue of DNS server A, the DNS request handler does not send the DNS request to server A. Instead, the DNS server attempts to place the DNS request in server B. The DNS request handler detects that 50 packets are pending in the input queue of DNS server B. Thus, the DNS request handler attempts to place the DNS request in DNS server C. DNS server C has 40 packets pending in its input queue. In this case, the DNS request handler assigns the incoming DNS request to the input queue of DNS server C.

Had DNS server C had 50 packets in the input queue, then the DNS request handler would again successively measure the number of packets in the input queues of DNS servers A and B. If less than 50 packets were in either queue, then the DNS request handler would assign the DNS request accordingly. Otherwise, DNS request handler may take some other action, such as to assign the DNS request randomly to one of DNS servers A, B, and C, drop the DNS request before the DNS request arrives at any of the DNS servers, or perform any other action desired.

The mechanism of the present invention has several advantages over currently available methods for processing DNS requests. For example, the DNS request workload is evenly distributed among all DNS servers in a group of DNS servers, thereby increasing the speed of processing DNS requests and better utilizing available server resources. In addition, all modifications required to implement the present invention may be performed on the server side, meaning that the client data processing system need not be configured in order for the present invention to function. Thus, the mechanism of the present invention is relatively easy to implement-.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing a DNS request, said method comprising:
receiving a DNS request at a first DNS server;
determining a length of a first input queue of DNS requests at the first DNS server; and
if the length of the first input queue exceeds a predetermined value, transferring the DNS request to a second DNS server before the DNS request times out.

2. The method of claim 1 further comprising:
after transferring the DNS request to the second DNS server, determining a length of a second input queue of DNS requests at the second DNS server; and
if the length of the second input queue exceeds a predetermined value, transferring the DNS request to a third DNS server before the DNS request times out.

3. The method of claim 1 further comprising:
after transferring the DNS request to the third DNS server, determining a length of a third input queue of DNS requests at the third DNS server; and
if the length of the third input queue exceeds a predetermined value, then before-the DNS request times out, managing the DNS request by performing a task selected from the group consisting of: retaining the DNS request at the third DNS server, transferring the DNS request to the second DNS server, and transferring the DNS request to the first DNS server.

4. The method of claim 3 wherein the task is selected by determining a current length of the queue at the first DNS server, a current length of the queue at the second DNS server, and a current length of the queue at the third DNS server, and thereafter selecting the task based on which DNS server has the shortest current queue.

5. The method of claim 4 further comprising:
dropping the DNS request if the first DNS server, the second DNS server, and the third DNS server each fail to process the DNS request.

6. The method of claim 1 further comprising:
processing the DNS request at the first DNS server if the length of the first input queue is less than or equal to the predetermined value.

7. The method of claim 1 further comprising:
processing the DNS request at the second DNS server if the length of the first input queue exceeds the predetermined value.

8. The method of claim 1 wherein the step of transferring is performed before the DNS request is added to the first input queue.

9. A computer program product comprising:
a computer usable medium having computer useable program code for managing a DNS request, said computer program product including:
computer usable program code for receiving a DNS request at a first DNS server;
computer usable program code for determining a length of a first input queue of DNS requests at the first DNS server; and
computer usable program code for, if the length of the first input queue exceeds a predetermined value, transferring the DNS request to a second DNS server before the DNS request times out.

10. The computer program product of claim 9 further comprising:
computer usable program code for, after transferring the DNS request to the second DNS server, determining a length of a second input queue of DNS requests at the second DNS server; and
computer usable program code for, if the length of the second input queue exceeds a predetermined value, transferring the DNS request to a third DNS server before the DNS request times out.

11. The computer program product of claim 9 further comprising:
computer usable program code for, after transferring the DNS request to the third DNS server, determining a length of a third input queue of DNS requests at the third DNS server; and
computer usable program code for, if the length of the third input queue exceeds a predetermined value, then before the DNS request times out, managing the DNS request by performing a task selected from the group consisting of:
retaining the DNS request at the third DNS server, transferring the DNS request to the second DNS server, and transferring the DNS request to the first DNS server.

12. The computer program product of claim 11 further comprising:
computer usable program code for selecting the task by determining a current length of the queue at the first DNS server, a current length of the queue at the second DNS server, and a current length of the queue at the third DNS server, and thereafter selecting the task based on which DNS server has the shortest current queue.

13. The computer program product of claim 12 further comprising:
computer usable program code for dropping the DNS request if the first DNS server, the second DNS server, and the third DNS server each fail to process the DNS request.

14. The computer program product of claim 9 further comprising:
computer usable program code for processing the DNS request at the first DNS server if the length of the first input queue is less than or equal to the predetermined value.

15. The computer program product of claim 9 further comprising:
computer usable program code for processing the DNS request at the second DNS server if the length of the first input queue exceeds the predetermined value.

16. The computer program product of claim 9 wherein the computer usable program code for transferring is adapted such that transferring is performed before the DNS request is added to the first input queue.

17. A data processing system for managing a DNS request, said data processing system comprising:
a bus;
a memory operably connected to the bus, wherein the memory contains a set of instructions;
a processor operably connected to the bus, wherein the processor executes the set of instructions to:
receive a DNS request at a first DNS server;
determine a length of a first input queue of DNS requests at the first DNS server; and
if the length of the first input queue exceeds a predetermined value, transfer the DNS request to a second DNS server before the DNS request times out.

18. The data processing system of claim 17 wherein the processor further executes the instructions to:
after transferring the DNS request to the second DNS server, determine a length of a second input queue of DNS requests at the second DNS server; and
if the length of the second input queue exceeds a predetermined value, transfer the DNS request to a third DNS server before the DNS request times out.

19. The data processing system of claim 17 wherein the processor further executes the instructions to:
after transferring the DNS request to the third DNS server, determine a length of a third input queue of DNS requests at the third DNS server; and
if the length of the third input queue exceeds a predetermined value, then before the DNS request times out, manage the DNS request by performing a task selected from the group consisting of: retaining the DNS request at the third DNS server, transferring the DNS request to the second DNS server, and transferring the DNS request to the first DNS server.

20. The data processing system of claim 19 wherein the processor further executes the instructions to:
select the task by determining a current length of the queue at the first DNS server, a current length of the queue at the second DNS server, and a current length of the queue at the third DNS server, and thereafter selecting the task based on which DNS server has the shortest current queue.
